(19) United States
(12) Patent Application Publication
(10) Pub. No.: US 2018/0307426 A1
(43) Pub. Date: Oct. 25, 2018

(54) STORAGE APPARATUS AND STORAGE CONTROL METHOD

(71) Applicant: FUJITSU LIMITED, Kawasaki-shi (JP)

(72) Inventors: Seiichi Sakai, Konan (JP); Katsuhiko Nagashima, Kawasaki (JP); TOSHIYUKI KIMATA, Nagoya (JP)

(73) Assignee: FUJITSU LIMITED, Kawasaki-shi (JP)

(21) Appl. No.: 15/947,939

(22) Filed: Apr. 9, 2018

(30) Foreign Application Priority Data
Apr. 20, 2017 (JP) 2017-083642

(51) Int. Cl. G06F 3/06; G06F 12/02

(52) U.S. Cl. CPC G06F 3/0631; G06F 12/023; G06F 3/0689; G06F 3/0662

(57) ABSTRACT

A storage apparatus includes a plurality of nodes, each of the plurality of nodes including a memory configured to store distributed data distributed and allocated to each of the plurality of nodes, and a processor coupled to the memory and configured to secure an empty storage region different from a storage region storing the distributed data on the memory when a new node is added to the plurality of nodes and move the distributed data to the empty storage region secured in the plurality of nodes and the new node.

### CROSS-REFERENCE TO RELATED APPLICATION

This application is based upon and claims the benefit of priority of the prior Japanese Patent Application No. 2017-83642, filed on Apr. 20, 2017, the entire contents of which are incorporated herein by reference.

### FIELD

The embodiment discussed herein is related to a storage apparatus and a storage control method.

### BACKGROUND

In the related art, by distributing and allocating data to each of a plurality of nodes, there is a technique of distributing input and output (I/O) with respect to the above data to each of the nodes. As a related art, for example, there is a technique of rearranging storage regions being allocated based on allocation information including an allocation status of the storage regions of the first and second storages according to a degree of bias generated between capacities of storage regions being allocated in the first storage and the second storage. In addition, when a second storage apparatus is added to a plurality of first storage apparatus, there is a technique of distributing data stored in a plurality of management units of a plurality of first disks into a plurality of management units of the plurality of first disks and second disks and storing the data.

Japanese Laid-open Patent Publication No. 2014-182508 and Japanese Laid-open Patent Publication No. 2009-230352 are examples of the related art.

### SUMMARY

According to an aspect of the invention, a storage apparatus includes a plurality of nodes, each of the plurality of nodes including a memory configured to store distributed data distributed and allocated to each of the plurality of nodes, and a processor coupled to the memory and configured to secure an empty storage region different from a storage region storing the distributed data on the memory when a new node is added to the plurality of nodes and move the distributed data to the empty storage region secured in the plurality of nodes and the new node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an operation example of a storage apparatus according to the embodiment;

FIG. 2 is an explanatory diagram illustrating a configuration example of a storage system;

FIG. 3 is an explanatory diagram illustrating a hardware configuration example of a node #0;

FIG. 4 is an explanatory diagram illustrating a functional configuration example of the node #0;

FIG. 5 is an explanatory diagram illustrating an example of an I/O standardization method;

FIG. 6 is an explanatory diagram illustrating a relationship between meta address data, logical-physical metadata, and a user data unit;

FIG. 7 is an explanatory diagram illustrating a functional configuration example of a metadata management unit and data processing management unit;

FIG. 8 is a flowchart illustrating an example of a data redistribution processing procedure;

FIG. 9 is an explanatory diagram illustrating an operation example of data redistribution processing;

FIG. 10 is a flowchart illustrating an example of a processing procedure at a time of write occurrence during data redistribution;

FIG. 11 is an explanatory diagram illustrating an operation example at the time of write occurrence during the data redistribution;

FIG. 12 is a flowchart illustrating an example of the processing procedure at a time of read occurrence during data redistribution;

FIG. 13 is an explanatory diagram illustrating an operation example at the time of read occurrence during the data redistribution;

FIG. 14 is an explanatory diagram illustrating an operation example of a data movement procedure by the metadata management unit;

FIG. 15 is a flowchart illustrating an example of a metadata movement processing procedure of a read I/O processing trigger; and

FIG. 16 is a flowchart illustrating an example of a background movement processing procedure other than an added node.

### DESCRIPTION OF EMBODIMENT

According to the related art, when distributed data distributed and allocated to each of the nodes of a plurality of nodes are distributed and allocated to a plurality of nodes and a new node, there may be an order restriction that next data may not be moved unless certain data is moved. When the order restriction occurs, the node that moves the above next data waits until the movement of certain data is completed, and it takes time to distribute and allocate the distributed data to the plurality of nodes and the new node, and to move the distributed data for waiting.

In one aspect, an object of the embodiment discussed herein is to provide a storage apparatus and a storage control program that may shorten the time taken to distribute and allocate distributed data which are distributed and allocated to each of the nodes of a plurality of nodes to the plurality of nodes and a new node and to move the distributed data.

Embodiments of the disclosed storage apparatus and storage control program will be described in detail below with reference to the drawings.

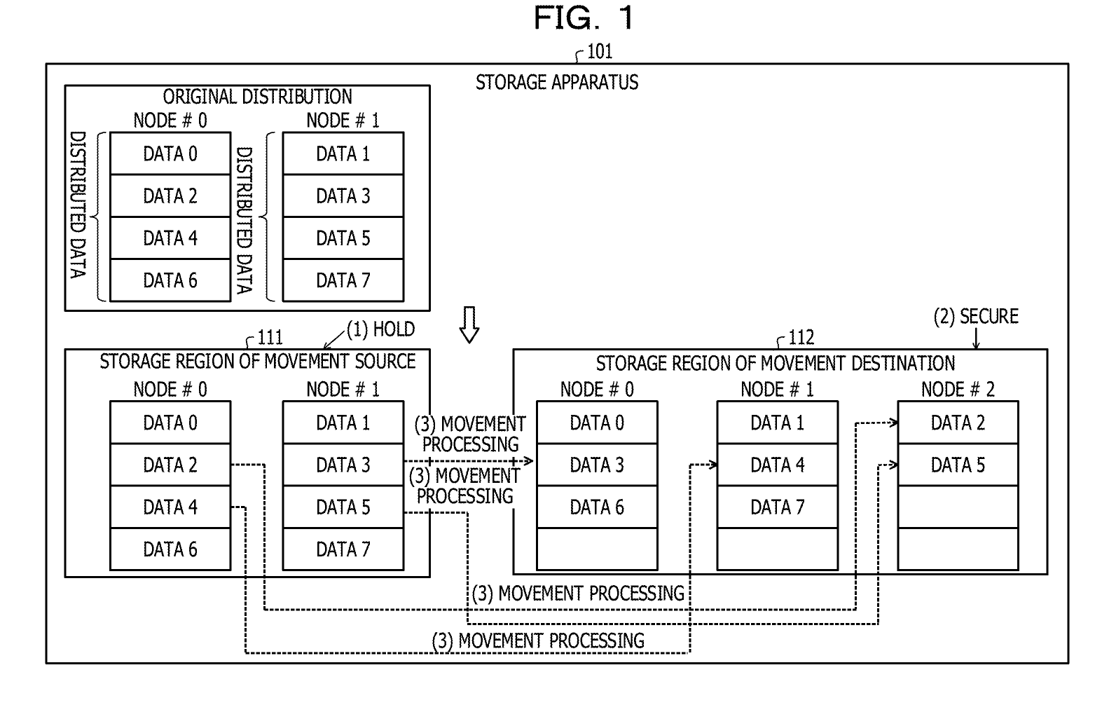

FIG. 1 is an explanatory diagram illustrating an operation example of a storage apparatus 101 according to the embodiment. The storage apparatus 101 is a computer that provides a storage region of storage. More specifically, the storage apparatus 101 has a plurality of nodes and provides the storage region of the storage of the node to a user of the storage apparatus 101. Each of the nodes of the plurality of nodes has a processor and the storage.

In order to distribute I/O load with respect to the storage region of the storage of the plurality of nodes, the storage apparatus 101 distributes and allocates the data stored in the storage regions of each of the storages of the plurality of nodes to each of the nodes of the plurality of nodes. Hereinafter, the data distributed and allocated to each of the nodes may be referred to as “distributed data”. In addition, the data of a portion of the distributed data may be referred to as “partial data”.

In an example at an upper portion of FIG. 1, the storage apparatus 101 has nodes #0 and #1, data 0, 2, 4 and 6 are allocated to the node #0 as the distributed data, and data 1, 3, 5, and 7 are allocated to the node #1 as the distributed data. Each of the data 0 to 7 is partial data. The data 0 to 7 are stored in storage of an allocated node. The data 0 to 7 are, for example, data included in one logical volume. As a technique for creating a logical volume, for example, there is a redundant arrays of inexpensive disks (RAID) technology which operates as a virtual logical volume by combining a plurality of storage apparatus.

In addition, a new node may be added to the storage apparatus 101. In this case, the distributed data distributed and allocated to each of the nodes is distributed and allocated to the plurality of nodes and the new node. Hereinafter, it is described as “redistribution” to distribute to the plurality of nodes and the new node. When redistributing, data movement occurs.

However, when redistributing, order restriction may occur in which the partial data of the distributed data is moved. For example, node #2 is added as a new node from a state disclosed at the upper portion of FIG. 1 and data is redistributed as follows.

Node #0: Data 0, 3, and 6

Node #1: Data 1, 4, and 7

Node #2: Data 2 and 5

In this case, for example, although the data 3 moves from the node #1 to the node #0, since the data 2 is present in a movement destination of the data 3, the data 2 is moved first before a movement of the data 3. In addition, for example, although data 4 moves from the node #0 to the node #1, since the data 3 is present in a movement destination of the data 4, the data 3 is moved first before movement of the data 4. When such an order restriction occurs that next data may not be moved unless certain data is moved, a node which moves the next data waits until a movement of the certain data is completed. In this manner, when the order restriction occurs, it takes time to distribute and allocate the distributed data to a plurality of nodes and a new node, and to move the distributed data for waiting.

In addition, I/O may occur from a user using the storage apparatus 101 while redistributing. For example, when a write request is generated, in a case where it is overwritten with new data, if movement is completed, it may be simply overwritten, but in a case where the movement is not completed, it is desirable that the movement is suppressed. Therefore, a movement map indicating whether or not the partial data of the distributed data is moved is created, and a state is monitored. In addition, it is efficient if it is possible to move the read-out partial data as it is when a read-out request occurs, but as described above, in a case where the order restriction occurs, the partial data may not be moved and the read-out partial data may not be used effectively.

Therefore, in the embodiment, when adding new nodes and redistributing the distributed data, it will be described that each of the nodes of the plurality of nodes holds the corresponding distributed data as a movement source and performs movement processing by allocating an empty storage region as a movement destination.

An operation example of the storage apparatus 101 will be described with reference to FIG. 1. As illustrated in (1) of FIG. 1, each of the nodes of the plurality of nodes holds the distributed data allocated to the nodes #0 and #1 as each node. In the example of FIG. 1, the node #0 holds a storage region where the data 0, 2, 4, and 6 which are the distributed data allocated to the node #0, are stored as a movement source of a storage region 111. Similarly, the node #1 holds a storage region where the data 1, 3, 5, and 7 which are the distributed data allocated to the node #1, are stored as the movement source of the storage region 111.

Next, as illustrated in (2) of FIG. 1, when redistributing, the nodes #0 and #1 as each node and the node #2 as a new node secure an empty storage region different from the storage region storing the distributed data. In the example of FIG. 1, the nodes #0 to #2 secure an empty region different from the storage region 111 of the movement source as a storage region 112 of the movement destination.

As described in (3) in FIG. 1, the nodes #0 and #1 as each node independently perform movement processing to move the held distributed data with respect to the storage region 112 of the movement destination for each node. Here, as a method of specifying a movement destination node of each partial data of the distributed data, for example, each node specifies a movement destination node from information on the post-node addition, an address of the partial data, and a predetermined allocation rule. For example, the information on the post-node addition may be the number of nodes after the node addition or identification information of the node after the node addition. In the above-described specifying method, for example, each of the nodes specifies a node that is identification information corresponding to a remainder obtained by dividing the address of the partial data by a data size of the partial data, and further dividing the obtained quotient by the number of nodes after the node addition as a movement destination node.

In the example of FIG. 1, in order to simplify the description, for each of the data 0 to 7, each of the nodes specifies the node corresponding to the remainder obtained by dividing numerical portions in the data 0 to 7 by 3 which is the number of nodes after the node addition in FIG. 1 as a movement destination node. Specifically, the node #0 specifies that the movement destination node of the data 2 is the node #2 and specifies that the movement destination node of the data 4 is the node #1. In addition, the node #1 specifies that the movement destination node of the data 3 is the node #0 and specifies that the movement destination node of the data 5 is the node #2.

Each of the nodes independently performs movement processing to move the partial data to the movement destination node corresponding to the corresponding partial data. Since the movement may be moved from anywhere simultaneously, each of the nodes may autonomously perform multiple movement processing, and it is possible to shorten the time taken for redistribution.

In addition, in a case where a write request of data to be written with respect to an address to be written is received after a new node has been added, each of the nodes and the new node may write the data to be written in the storage region 112 of the movement destination secured by the own node. Here, the address with respect to the data is a physical address when providing the user of the storage apparatus 101 with a physical address of the storage apparatus 101, and is a logical address when providing with a logical address corresponding to the physical address. In a case where the partial data is received, when the data is not written in the address of the received partial data in the storage region 112 of the movement destination, each of the nodes and the new node write the received partial data in the storage region 112 of the movement destination secured by the own node.

For example, in the example of FIG. 1, in order to simplify the description, it is assumed that the numerical portion of the data 0 to 7 is an address. It is assumed that the node #1 receives a write request of the data 4 before performing the movement processing of the data 4 by the node #0. In this case, the node #1 writes the data 4 in the storage region 112 of the movement destination. In a case where the data 4 is received from the node #0, the address of the data 4 in the storage region 112 of the movement destination includes the data written by the above-mentioned write request. Accordingly, the node #1 does not write the received partial data in the storage region 112 of the movement destination secured by the node #1, and discards the received data 4. In addition, although not illustrated in FIG. 1, it is assumed that the node #1 receives the other partial data other than the data 4 from the node #0. In this case, when there is no data in the address of the other partial data in the storage region 112 of the movement destination, the node #1 writes the other partial data in the storage region 112 of the movement destination secured by the node #1.

In this manner, whether or not the partial data of the movement destination is valid may be determined by a presence or absence of the partial data in the storage region 112 of the movement destination, so that each of the nodes and the new node may not use monitoring on the movement map.

In addition, in a case where a read-out request with respect to an address to be read-in is received after a new node has been added, each of the nodes and the new node determine whether or not there is partial data with respect to an address to be read-out in the storage region 112 of the movement destination secured by the own node. When there is no partial data with respect to the address to be read-out in the storage region 112 of the movement destination, each of the nodes and the new node transmit an acquisition request of the partial data including the address to be read-out to the node specified by a method of specifying the movement source node. Here, in the method of specifying the movement source node, the information on the node after node addition in the above-described method of specifying the movement destination node is merely replaced with the information on the node before the node addition. In a case where the acquisition request is received, the above specified node transmits the partial data corresponding to the address to be read-out in the storage region 111 of the movement source from the distributed data allocated to each of the nodes to a transmission source node of the acquisition request. The transmission source node of the acquisition request transmits the received partial data to a transmission source of the read-out request and writes the received partial data in the storage region 112 of the movement destination secured by the own node.

For example, it is assumed that node #1 receives a read-out request of the data 4 before performing the movement processing of the data 4 by the node #0. In this case, the node #1 determines whether or not there is partial data with respect to the address to be read-out in the storage region 112 of the movement destination secured by the own node. In this case, since there is not the data 4 in the storage region 112 of the movement destination, the node #1 transmits the acquisition request of the data 4 to the node #0 specified by the method of specifying the movement source node. The node #0 transmits the data 4 in the storage region 111 of the movement source to the node #1 as a transmission source node of the acquisition request. The node #1 transmits the received data 4 to the transmission source of the read-out request and writes the data 4 in the storage region 112 of the movement destination secured by the own node.

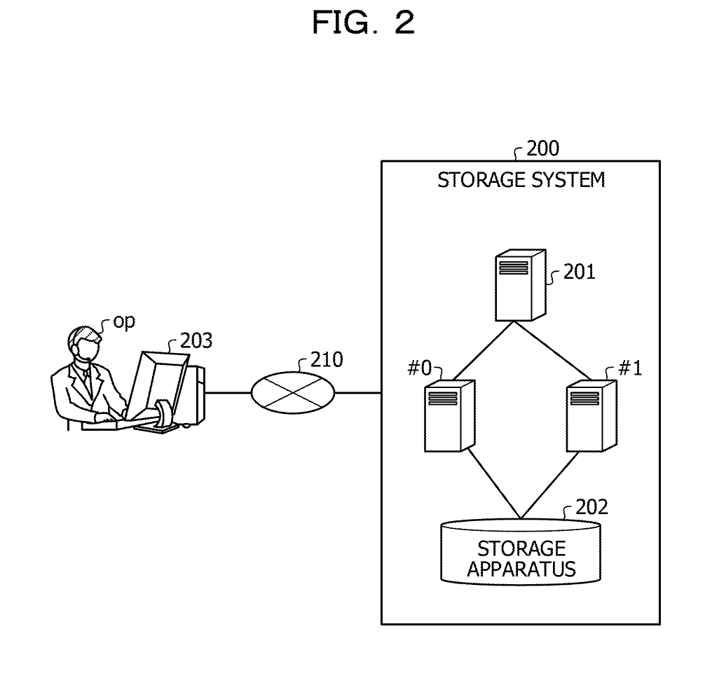

As a result, since the order restriction does not occur, each of the nodes and the new node may move the read-out partial data as it is. Next, an example in which the storage apparatus 101 is applied to a storage system 200 will be described with reference to FIG. 2.

FIG. 2 is an explanatory diagram illustrating a configuration example of the storage system 200. The storage system 200 includes nodes #0 and #1 serving as storage control apparatus, a business server 201, and a storage (storage apparatus) 202. In addition, the storage system 200 is connected to an operator terminal 203 via a network 210 such as the Internet, a local area network (LAN), a wide area network (WAN), or the like.

The business server 201 is a computer that uses a storage region of the storage 202. The business server 201 is, for example, a Web server or a data base (DB) server.

The storage apparatus 202 is a nonvolatile memory that stores data. For example, the storage apparatus 202 is a solid state drive (SSD) including a semiconductor memory formed by semiconductor elements. In addition, there are a plurality of storage apparatus 202 to form a RAID. In addition, since the storage apparatus 202 is accessed from the nodes #0 and #1, although the storage apparatus 202 is connected from the nodes #0 and #1 by arrows in FIG. 2, the storage apparatus 202 is not limited thereto. For example, the storage apparatus 202 may be in the node #0, in the node #1, or outside the nodes #0 and #1.

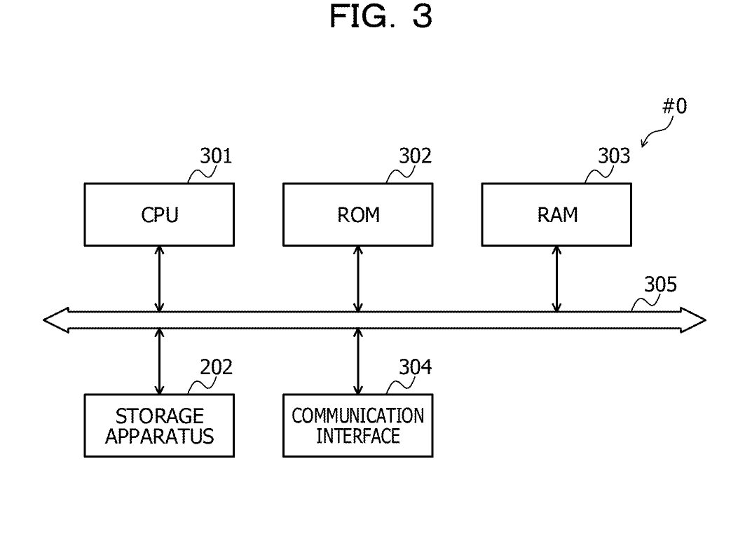

The operator terminal 203 is a computer operated by an operator op performing an operation on the storage system 200. Next, a hardware configuration of the node #0 will be described with reference to FIG. 3.

In the example of FIG. 2, although the storage system 200 has two nodes, the storage system 200 may have three or more nodes. Next, the hardware configuration of the node #0 will be described as the hardware configuration of the node with reference to FIG. 3. Since other nodes such as the node #1 have the same hardware as the node #0, the description will be omitted.

FIG. 3 is an explanatory diagram illustrating a hardware configuration example of a node #0. In FIG. 3, the node #0 includes a central processing unit (CPU) 301, a read-only memory (ROM) 302, a random access memory (RAM) 303, a storage apparatus 202, and a communication interface 304. In addition, the CPU 301 to the RAM 303, the storage apparatus 202, and the communication interface 304 are connected via a bus 305, respectively.

The CPU 301 is an arithmetic processing unit that controls the entire node #0. In addition, the CPU 301 may have a plurality of processor cores. The ROM 302 is a nonvolatile memory that stores a program such as a boot program. The RAM 303 is a volatile memory used as a work area of the CPU 301.

The communication interface 304 is a control device that controls the network and the internal interface and controls input and output of data from other devices. Specifically, the communication interface 304 is connected to another apparatus through a communication line via a network. As the communication interface 304, for example, a modem, a LAN adapter, or the like can be adopted.

In addition, in a case where the operator op directly operates the node #0, the node #0 may have hardware such as a display, a keyboard, and a mouse.

In addition, the business server 201 has a CPU, a ROM, a RAM, a disk drive, a disk, and a communication interface. In addition, the operator terminal 203 has a CPU, a ROM, a RAM, a disk drive, a disk, a communication interface, a display, a keyboard, and a mouse.

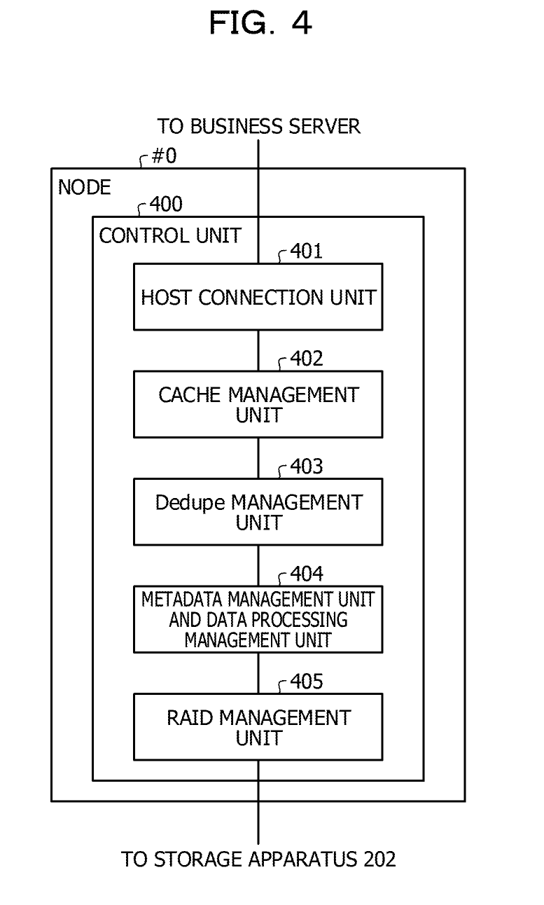

Next, a function of the node #0 will be described with reference to FIG. 4. In addition, since other nodes such as the node #1 have the same hardware as the node #0, the description will be omitted.

FIG. 4 is an explanatory diagram illustrating a functional configuration example of the node #0. The node #0 has a control unit 400. The control unit 400 has a host connection unit 401, a CACHE management unit 402, a Dedupe (overlap) management unit 403, a metadata management unit and data processing management unit 404, and a device management unit 405. In the control unit 400, the CPU 301 executes the program stored in the storage apparatus, so that the functions of the respective units are realized. Specifically, the storage device is, for example, the ROM 302, the RAM 303, the disk unit 202, and the like illustrated in FIG. 3. In addition, the processing result of each unit is stored in the RAM 303, a register of the CPU 301, a cache memory of the CPU 301, or the like.

The host connection unit 401 exchanges information with protocol drivers such as a fibre channel (FC)/an internet small computer system interface (iSCSI) and the CACHE management unit 402 to RAID management unit 405.

The CACHE management unit 402 manages user data on the RAM 303. Specifically, the CACHE management unit 402 schedules Hit or Miss determination, Staging or Write Back with respect to I/O.

The Dedupe management unit 403 manages unique user data stored in the storage apparatus 202 by controlling deduplication or restoration of data.

Here, the metadata management unit and data processing management unit 404 manages first address information and second address information. The first address information corresponds to the partial data of the distributed data distributed and allocated to each of the nodes of the plurality of nodes illustrated in FIG. 1. The first address information is information having a logical address and a physical address indicating a storage position storing data corresponding to the above logical address. In addition, the second address information is information having a physical address indicating the storage position of the first address information corresponding to the first address information. Hereinafter, the data corresponding to the logical address will be referred to as “user data”, the first address information will be referred to as “logical-physical metadata”, and the second address information will be referred to as “meta address data”.

More specifically, the metadata management unit and data processing management unit 404 manages the meta address data and the logical-physical metadata as a metadata management unit, and manages a user data unit (referred to as data log) indicating a region to store the user data as a data processing management unit. The metadata management unit performs conversion processing between the logical address of a virtual volume and the physical address of a physical region by using the meta address data and the logical-physical metadata. In addition, the data processing management unit manages the user data in a continuous log structure, and additionally writes the user data in the storage (storage apparatus) 202. The data processing management unit manages compression and decompression of the data, and a physical space of a drive group, and performs the data arrangement.

As the data arrangement, when updating the meta address data, the data processing management unit stores the updated meta address data at a position corresponding to the logical address of the logical-physical metadata corresponding to the updated meta address data in the consecutive storage regions. Here, the position corresponding to the logical address is, for example, an RU positioned at the quotient value obtained by dividing the logical address by the size of the meta address data. In addition, when updating the user data unit or the logical-physical metadata, the data processing management unit stores the updated user data unit or the updated logical-physical metadata in an empty storage region different from the storage region storing the user data unit and the logical-physical metadata.

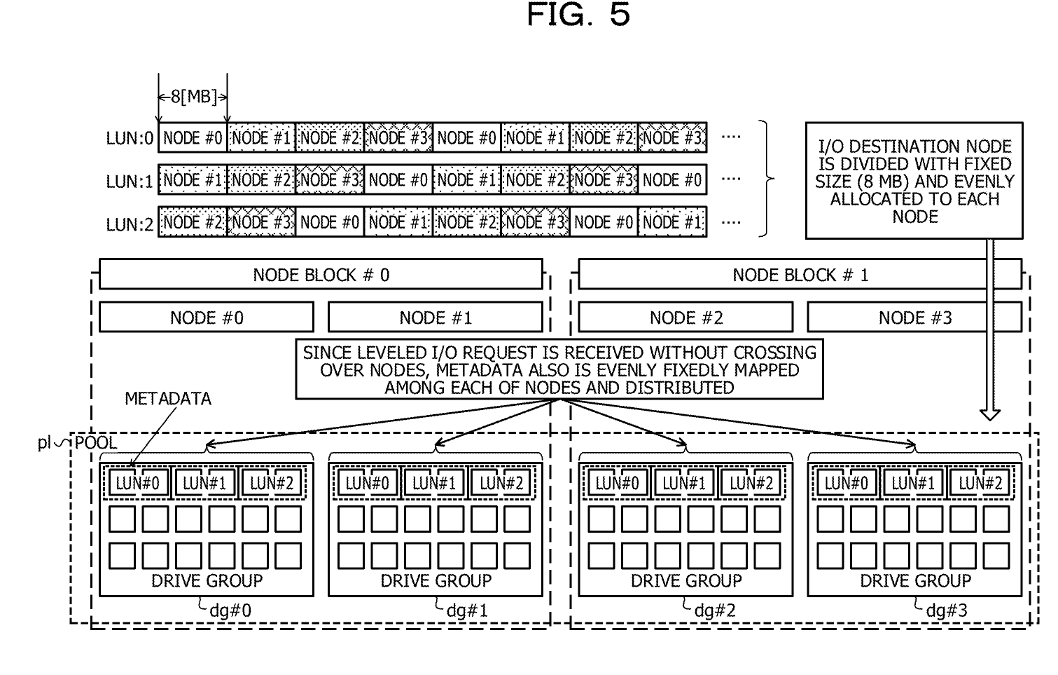

The unit of physical allocation of thin provisioning is normally performed in units of chunk having fixed size, and one chunk corresponds to one RAID unit. In the following description, the chunk is referred to as a RAID unit. The RAID management unit 405 forms one RAID unit with one chunk of data and allocates to a drive group in units of RAID unit. The meta address data, the logical-physical metadata, the user data unit, and the drive group will be described with reference to FIG. 5.

FIG. 5 is an explanatory diagram illustrating an example of an I/O standardization method. In order to level I/O between the nodes, the storage system 200 divides the I/O destination node in a fixed size using a logical unit number (LUN) and the logical address of the logical volume as keys and equally allocates the divided I/O destination node to each of the nodes. For example, the logical address is indicated by logical block addressing (LBA). In addition, for example, the fixed size is 8 MB. By dividing the I/O destination node with a fixed size and evenly allocating the divided I/O destination node to each node, the metadata of one logical volume and the user data unit are distributed and allocated to the entire nodes.

For example, in the example of FIG. 5, the I/O destination node at the head of LUN: 0 of 8 MB is the node #0, and the next I/O destination node of 8 MB is the node #1. In the example of FIG. 5, for an I/O destination node of LUN: 0 to 2, the node #0 is illustrated by a hollow rectangle, the node #1 is illustrated by a shaded rectangle with sparse polka dots, the node #2 is illustrated by a shaded rectangle with dense polka dots, and the node #3 is illustrated by a shaded rectangle with an oblique lattice pattern. For example, as illustrated in FIG. 5, I/O destination nodes of each LUN: 0 to 2 are distributed to the nodes #0 to #3.

Each of the nodes is included in any of a plurality of node blocks. In the example of FIG. 5, the nodes #0 and #1 are included in the node block #0, and the nodes #2 and #3 are included in the node block #1. One or more pools are provided in one node block. In the example of FIG. 5, there is a pool pl in the node blocks #0 and #1.

In addition, each of the nodes has a corresponding drive group. The drive group is a pool of RAID 6 formed from a plurality of storage apparatus 202 and corresponds to a RAID group. In FIG. 5, drive groups dg #0 to #3 corresponding to nodes #0 to #3 are present.

In addition, in FIG. 5, the solid square in the drive group dg is a RAID unit (RU). The RU is a continuous physical region of approximately 24 MB physically allocated from the pool. For the correspondence between the I/O destination node of LUN: 0 to 2 in the upper portion of FIG. 5 and the RU in the lower portion of FIG. 5, for example, the first 8 MB of LUN: 0 corresponds to the first RU from the left in the highest row of the drive group dg #0. In addition, the next 8 MB of LUN: 0 corresponds to the first RU and the second RU from the left in the highest row of drive group dg #1. In addition, the metadata and the user data units are stored in the RU. In this manner, since the leveled I/O request is received without crossing over the nodes, the metadata is evenly fixedly mapped among each of the nodes and distributed.

In the example of FIG. 5, the metadata is data illustrated by broken lines in the drive groups dg #0 to #3. In addition, in the example of FIG. 5, each piece of metadata is data of two RUs, but it is not limited thereto, and it may be data of one RU or three or more RUs in some cases. In addition, the user data unit corresponding to the metadata is stored in any one of the RUs in the drive group dg in which the metadata is stored. For example, the first 8 MB I/O destination node of LUN: 1 is node #1, and the metadata is stored in the third RU and the fourth RU from the left in the uppermost row of the drive group dg #1. The user data unit corresponding to the above metadata is stored in any one of the RUs of the drive group dg #1.

The metadata is a generic name of the logical-physical metadata and the meta address data. The logical-physical metadata is information to manage a physical position where the LBA of the logical volume and the user data unit are stored. The logical-physical metadata is managed in units of 8 kB. More specifically, the logical-physical metadata includes an RU number in which the user data unit corresponding to the corresponding logical-physical metadata is stored, and the offset position of the above user data unit in the RU in which the user data unit corresponding to the corresponding logical-physical metadata is stored. The meta address data is information to manage the physical position where the logical-physical metadata is stored. The meta address data is managed in units of the logical-physical metadata. More specifically, the meta address data includes an RU number in which the logical-physical metadata corresponding to the corresponding meta address data is stored, and the offset position of the above logical-physical metadata in the RU in which the logical-physical metadata corresponding to the corresponding meta address data is stored.

The user data unit indicates a storage region storing compressed user data, and has, for example, a data section storing compressed data in units of 8 KB and a header section (referred to as reference meta). A hash value of the compressed data and the information of the logical-physical meta to point the compressed data are stored in the header section. The hash value of the compressed data is, for example, a value calculated by secure hash algorithm 1 (SHA 1). The hash value is used as a keyword when searching duplicates.

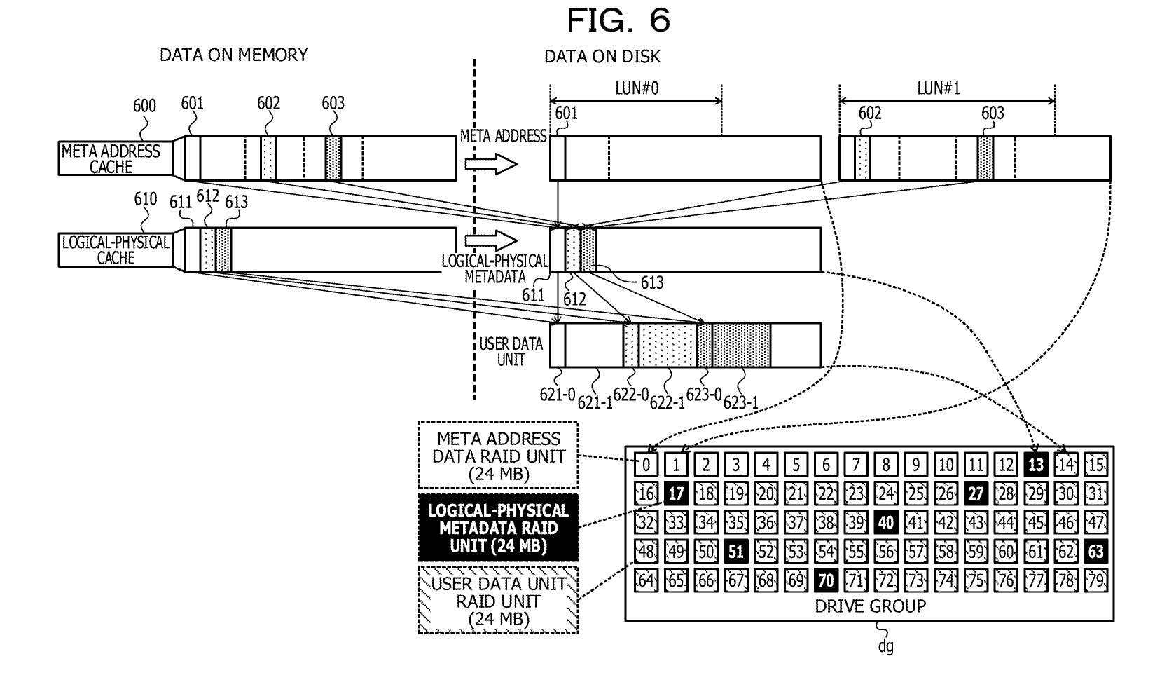

Next, the relationship between the meta address data, the logical-physical metadata, and the user data unit will be described with reference to FIG. 6.

FIG. 6 is an explanatory diagram illustrating a relationship between the meta address data, the logical-physical metadata, and the user data unit. FIG. 6 illustrates the structure on the memory and on the disk regarding the relationship between the meta address data, the logical-physical metadata, and the user data unit. Furthermore, FIG. 6 illustrates an example of arrangement of the meta address data, the logical-physical metadata, and the user data unit in the drive group dg.

In the example of FIG. 6, the left side of FIG. 6 illustrates the data arrangement on the memory such as the RAM 303 in the nodes #0, #1, and the center and the right side of FIG. 6 illustrate examples of data arrangement on the storage apparatus 202. FIG. 6 illustrates the three meta address data 601 to 603 and the logical-physical metadata and user data unit corresponding to each of the meta address data 601 to 603. Here, in FIG. 6, the meta address data 601, the logical-physical metadata corresponding to the meta address data 601, and the user data unit are illustrated by hollow rectangles. In addition, the meta address data 602, the logical-physical metadata corresponding to the meta address data 602, and the user data unit are illustrated by shaded rectangles with sparse polka dots. In addition, the meta address data 603, the logical-physical metadata corresponding to the meta address data 603, and the user data unit are illustrated by shaded rectangles with dense sparse polka dots.

In FIG. 6, there is a drive group dg in the storage apparatus 202, and each RU of the drive group dg stores any one of the meta address data, the logical-physical metadata, and the user data unit. Each RU of the drive group dg illustrated in FIG. 6 is illustrated by a hollow rectangle in a case where a meta address is stored, illustrated by a solid rectangle in a case where logical-physical metadata is stored, and illustrated by a rectangle with oblique lines from the upper right to the lower left in a case where a user data unit is stored.

As described in FIG. 4, the meta address data is arranged in consecutive RUs in the drive group dg in a logical unit (LUN unit). The meta address data is overwritten and stored in a case of updating. On the other hand, since the logical-physical metadata and the user data unit are written in a write-once type, the logical-physical metadata and the user data unit are skipped among the RUs like the drive group dg illustrated in FIG. 6. For example, in the example of FIG. 6, when the amount of data exceeds a predetermined threshold at a certain point as a result of the logical-physical metadata being written in the write-once type in the logical-physical cache, RU: 17 is allocated and the logical-physical metadata is written in the drive group RU: 17 from the logical-physical cache. Therefore, the logical-physical metadata RU: 13 and RU: 17 are written with a time difference, and since the RU of the user data unit is written in 14 to 16 therebetween, RU: 13 and RU: 17 are skipped.

FIG. 6 illustrates details of data of RU: 0, 1, 13, and 14. RU: 0 includes the meta address data 601 in LUN #0. In addition, RU: 1 includes the meta address data 602 and 603 in LUN #1. In addition, RU: 13 includes the logical-physical metadata 611 to 613 corresponding to the meta address data 601 to 603. In addition, RU: 14 includes the user data unit 621-0 and 621-1 corresponding to the meta address data 601, the user data unit 622-0 and 622-1 corresponding to the meta address data 602, and the user data unit 623-0 and 623-1 corresponding to the meta address data 603. Here, the reason why the user data unit is divided into two is that the user data unit 62x-0 indicates the header section and the user data unit 62x-1 indicates the compressed user data.

In addition, in FIG. 6, a meta address cache 600 and a logical-physical cache 610 are secured on the memories of the nodes #0 and #1. The meta address cache 600 caches a portion of the meta address data. In the example of FIG. 6, the meta address caches 600 caches the meta address data 601 to 603. In addition, the logical-physical cache 610 caches the logical-physical metadata. In the example of FIG. 6, the logical-physical cache 610 caches the logical-physical metadata 611 to 613.

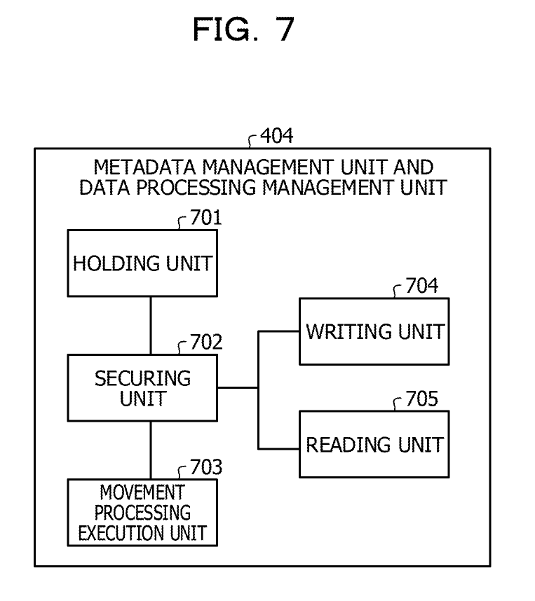

FIG. 7 is an explanatory diagram illustrating a functional configuration example of a metadata management unit and data processing management unit 404. The metadata management unit and data processing management unit 404 includes a holding unit 701, a securing unit 702, a movement processing execution unit 703, a writing unit 704, and a reading unit 705. First, the processing (1) to (3) illustrated in FIG. 1, that is, a function when a new node is added will be described.

The holding unit 701 holds the logical-physical metadata allocated to each of the nodes, the user data unit corresponding to the logical address of the corresponding logical-physical metadata, and the meta address data corresponding to the corresponding logical-physical metadata when allocating the logical-physical metadata at the time of redistributing.

When allocating the logical-physical metadata, the securing unit 702 secures the first empty storage region and the second empty storage region serving as a continuous empty storage region, which are different from the storage region storing the data held by the holding unit 701. Here, the data held by the holding unit 701 is data corresponding to the logical address of the logical-physical metadata and the corresponding logical-physical metadata, and the corresponding logical-physical metadata.

The movement processing execution unit 703 independently performs the movement processing to move the logical-physical metadata to the empty storage region secured by the securing unit 702 for each of the nodes. Specifically, the movement processing execution unit 703 in each of the nodes as a movement source transmits the logical-physical metadata allocated to each of the nodes as movement processing to a node specified based on the method of specifying the movement destination node described in FIG. 1 among each of the nodes and the new node. The movement processing execution unit 703 in the specified node writes the received logical-physical metadata in the first empty storage region secured by the own node. In addition, the movement processing execution unit 703 in the specified node writes the meta address data having the physical address indicating the storage position in which the received logical-physical metadata is written in the second empty storage region.

Next, a case where a write request of data to be written with respect to an address to be written is received after a new node has been added will be described. In this case, the writing unit 704 of the node received the write request among each of the nodes and the new nodes writes the data to be written in the first empty storage region secured by the own node. In addition, the writing unit 704 of the node received the write request writes the logical-physical metadata having the physical address indicating the storage position of the data to be written and the logical address to be written in the first empty storage region secured by the own node. In addition, the writing unit 704 of the node received the write request writes the meta address data having the physical address indicating the storage position of the logical-physical metadata written in the first empty storage region in the second empty storage region secured by the own node.

In a case where the logical-physical metadata is received by the movement processing, the movement processing execution unit 703 of each of the nodes and the new node determines whether the logical address of the received logical-physical metadata is different from the logical address of the logical-physical metadata written in the first empty storage region secured by the own node. Here, the above movement processing execution unit 703 may determine whether the two logical addresses are different from each other, for example, based on whether or not the meta address data already exists at a position corresponding to the logical address of the received logical-physical metadata in the second empty region. In a case where the meta address data already exists at the position corresponding to the logical address of the received logical-physical metadata in the second empty region, it may be determined that the two logical addresses coincide with each other, and in a case where there is no meta address data in the corresponding position yet, it may be determined that the two logical addresses are different from each other. When the two logical addresses are different from each other, the above movement processing execution unit 703 writes the received logical-physical metadata in the first empty storage region secured by the own node.

Next, a case where a read-out request with respect to an address to be read-out is received after a new node has been added will be described. In this case, the reading unit 705 of the node received the read-out request among each of the nodes and the new nodes determines whether or not there is data with respect to the logical address to be read-out in the first empty storage region secured by the own node. When there is no data with respect to the logical address to be read in the first empty storage region, the above reading unit 705 transmits the acquisition request of the logical-physical metadata including the logical address to be read-out to the node specified based on the method of specifying the movement source node described in FIG. 1. In a case where the acquisition request is received, the reading unit 705 in the above specified node transmits the logical-physical metadata including the logical address to be read from the held logical-physical metadata to the transmission source node of the acquisition request. In a case where the logical-physical metadata is received, the reading unit 705 in each of the nodes and the new node reads the user data unit stored in the physical address of the received logical-physical metadata.

For Addition of Node

Next, a procedure to add a node to the storage system 200 will be described. The operator op adds a node in hardware according to a node addition method procedure. Next, the operator terminal 203 provides a graphical user interface (GUI) to the operator op, and a pool expansion is performed by adding a drive group using the storage apparatus 202 of the addition node to the existing pool by the operation of the operator op.

Upon the expansion of the pool, the metadata management unit moves metadata including logical-physical metadata and meta address data. Specifically, for the logical-physical metadata, the metadata management unit copies the logical-physical metadata recorded in the storage apparatus 202 of an old assigned node to a disk of a new assigned node. Here, since the logical-physical metadata is written additionally, the arrangement within the storage apparatus 202 is random. On the other hand, for the meta address data, the metadata management unit moves after determining the position of the logical-physical metadata. The reason is that the meta address data of the movement destination includes information on the recording position of the logical-physical metadata in the new assigned node. Accordingly, it is possible to fix the meta address data after moving the logical-physical metadata.

In addition, while the metadata is moving, each of the nodes continues to receive I/O and continues processing corresponding to the received I/O. The user data unit does not move. Upon the expansion of the pool, each of the nodes writes a user data unit by a new write in a disk of an assigned node after leveling with the new node configuration.

In addition, regarding the addition of the node, it is desirable to apply the load distribution method in which load is distributed before adding the node, while continuing operation even after adding the node. Therefore, it is desirable to redistribute the user data distributed in the node configuration before adding the node and the management data of the storage system 200 in the node configuration after adding the node. In addition, each of the nodes is desirable to continue the operation even while data redistribution is in progress. In order to continue the operation even while the data redistribution is in progress, it is desirable to be capable of access data stored before and after adding the node and to be capable of pool creation, delete, volume creation, delete, and new write.

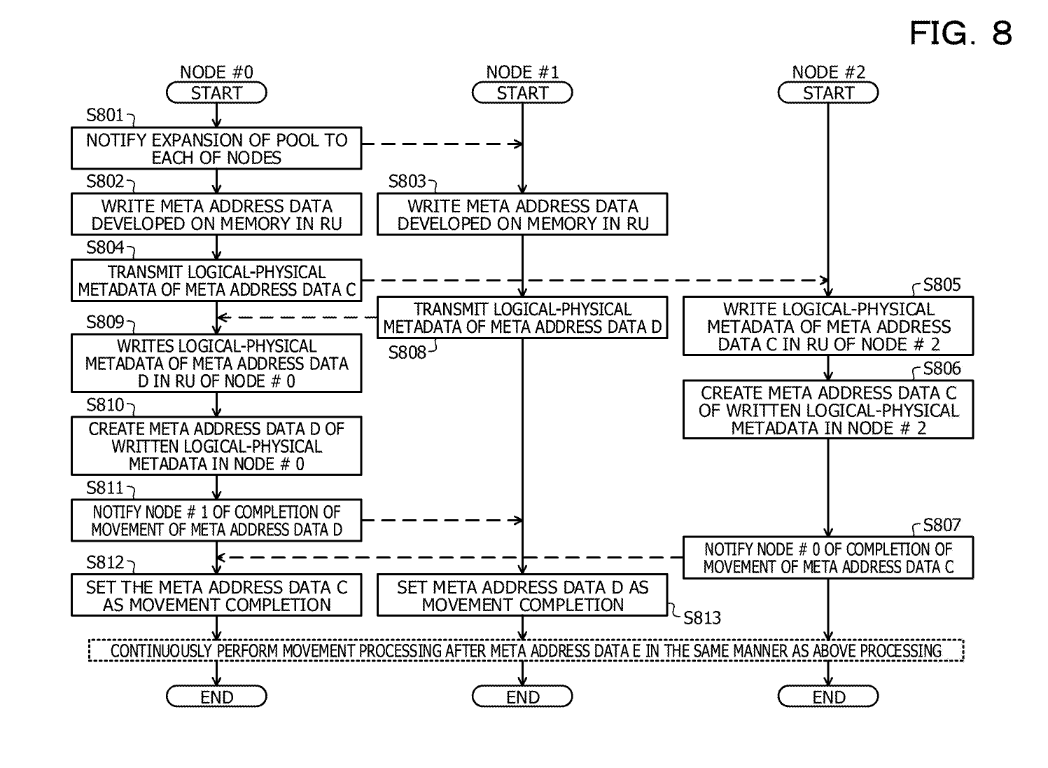

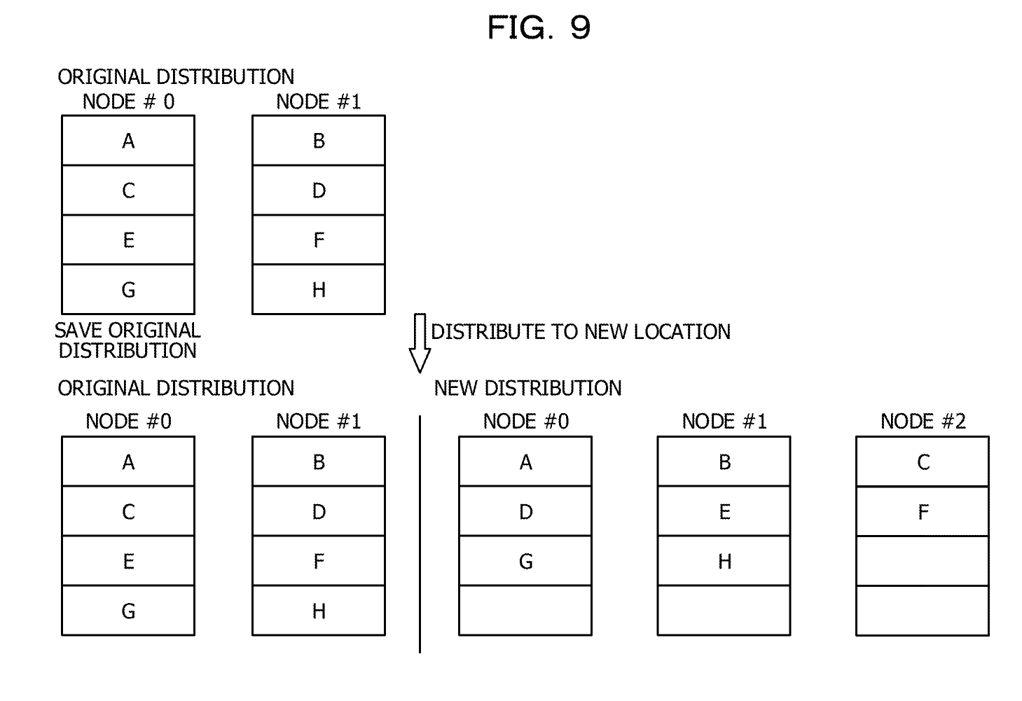

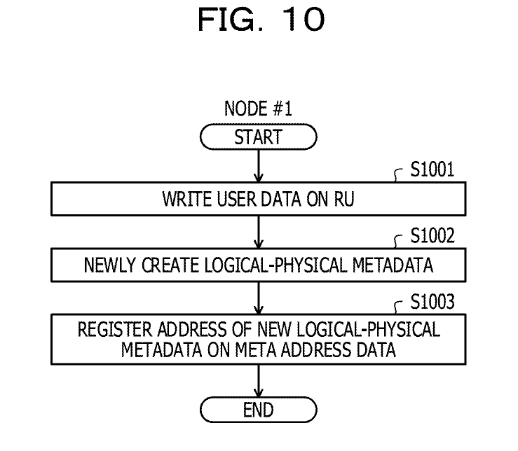

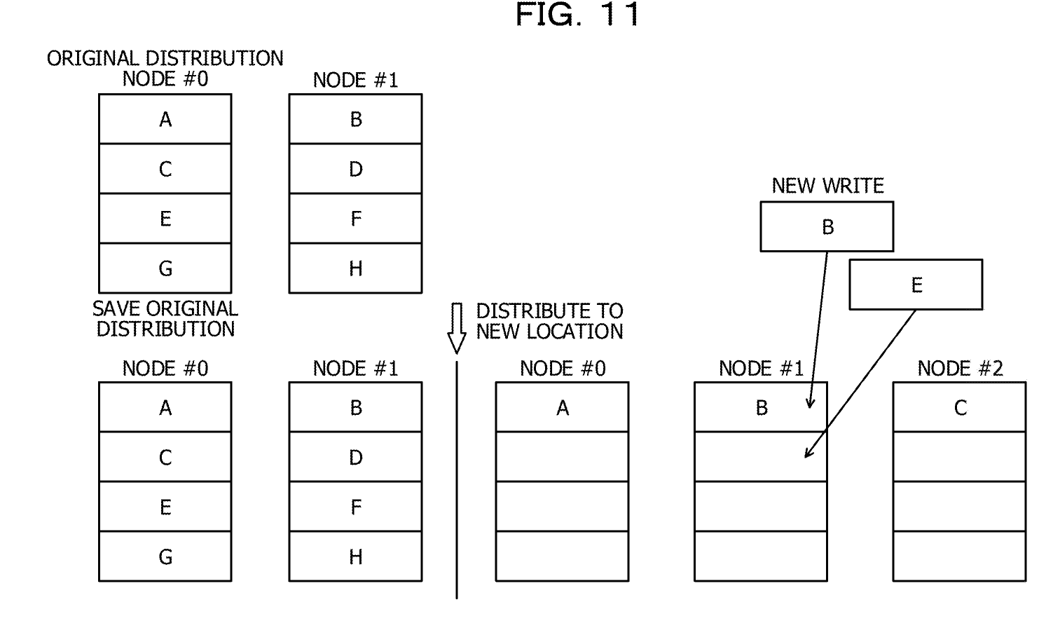

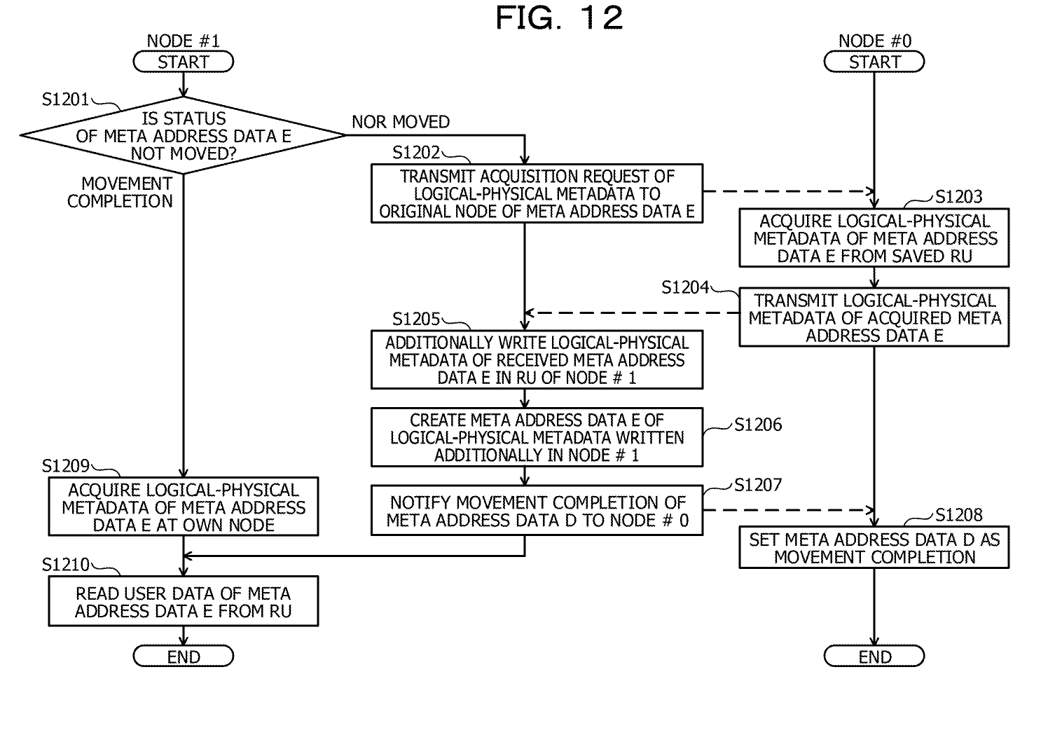

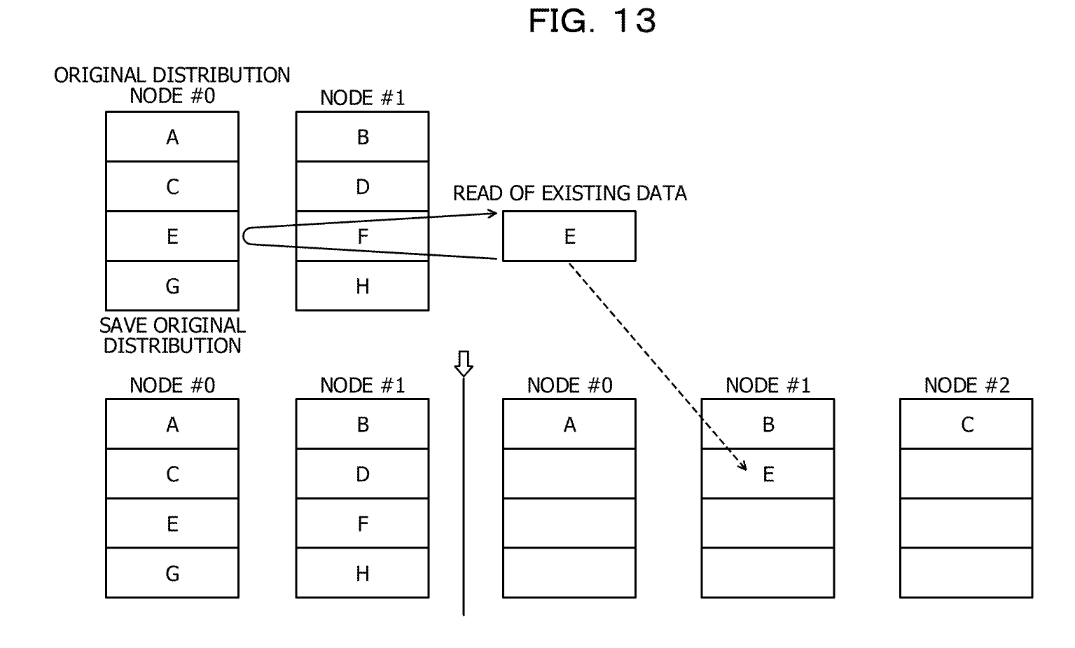

Next, a flowchart of data redistribution processing is illustrated in FIG. 8, and an operation example of the data redistribution processing is illustrated in FIG. 9. In addition, a flowchart of processing at a time of write occurrence during the data redistribution is illustrated in FIG. 10, and an operation example of processing at the time of write occurrence during the data redistribution is illustrated in FIG. 11. In addition, a flowchart of processing at the time of read occurrence during the data redistribution is illustrated in FIG. 12, and an operation example of processing at the time of read occurrence during the data redistribution is illustrated in FIG. 13. The broken arrows illustrated in FIGS. 8 and 12 describe that data is transmitted between the nodes.

FIG. 8 is a flowchart illustrating an example of a data redistribution processing procedure. In addition, FIG. 9 is an explanatory diagram illustrating an operation example of the data redistribution processing. In FIGS. 8 and 9, an example is illustrated in which data is distributed at the nodes #0 and #1, and the node #2 is added as an additional node. In the data redistribution processing, the original distribution is saved as it is and used as the movement source information. In addition, the storage location of data in the new distribution after the data redistribution is assumed to be secured in advance at the time of creating the logical volume. In addition, as illustrated in the upper portion of FIG. 9, in the original distribution, the node #0 has a meta address data A, C, E, and G and further has a logical-physical metadata corresponding to each of the meta address data A, C, E, and G. In addition, the node #1 has a meta address data B, D, F, and H and further has a logical-physical metadata corresponding to each of the meta address data B, D, F, and H.

The node #0 notifies the expansion of the pool to each of the nodes before the data distribution (Step S801). The nodes #0 and #1 write the meta address data developed on the memory in the RU (Steps S802 and S803).

After the processing in Steps S802 and S803 is completed, each of the nodes transmits the logical-physical metadata in which a node other than the own node is a new assigned node among the saved movement source information to the corresponding node. In the example of FIG. 9, in the node #0, the meta address data C is data in which a node other than the own node is a new assigned node. In addition, in the node #1, the meta address data D and F are data in which nodes other than the own node are new assigned nodes.

Accordingly, the node #0 transmits the logical-physical metadata of the meta address data C among the logical-physical metadata possessed by the node #0 to the node #2 (Step S804). The node #2 writes the logical-physical metadata of the meta address data C in the RU of the node #2 (Step S805). The node #2 creates the meta address data C of the written logical-physical metadata in the node #2 (Step S806) and notifies the node #0 of the completion of movement of the meta address data C (Step S807).

In a case of transmitting the logical-physical metadata of the metadata address data, the logical-physical metadata is already transmitted by the read during data redistribution which will be described later in some cases. Accordingly, when the status of the meta address data is not moved, the old assigned node transmits the logical-physical metadata of the meta address data. In addition, in a case where the logical-physical metadata of the meta address data is received, there is a possibility that the logical-physical metadata already exists due to write during the data redistribution which will be described later. Accordingly, in a case where there is no logical-physical metadata of the received meta address data, the new assigned node writes the logical-physical metadata of the received meta address data in the own RU.

Similarly, the node #1 transmits the logical-physical metadata of the meta address data D among the logical-physical metadata possessed by the node #1 to the node #0 (Step S808). The node #0 writes the logical-physical metadata of the meta address data D in the RU of the node #0 (Step S809). The node #0 creates the meta address data D of the written logical-physical metadata in the node #0 (Step S810) and notifies the node #1 of the completion of movement of the meta address data D (Step S811).

The node #0 received the notification of the movement completion from the node #2 sets the meta address data C as movement completion (Step S812). Similarly, the node #1 received the notification of the movement completion from the node #0 sets the meta address data D as movement completion (Step S813). Regarding the subsequent processing, the nodes #0 to #2 continuously perform the movement processing after the meta address data E in the same manner as the above processing, and the data redistribution processing is terminated.

As illustrated in the lower portion of FIG. 9 after the movement of the data is completed, in the new distribution, the node #0 has a meta address data A, D, and G and further has a logical-physical metadata corresponding to each of the meta address data A, D, and G. In addition, the node #1 has a meta address data B, E, and H and further has a logical-physical metadata corresponding to each of the meta address data B, E, and H. In addition, the node #2 has a meta address data C and F and further has a logical-physical metadata corresponding to each of the meta address data C and F.

FIG. 10 is a flowchart illustrating an example of a processing procedure at a time of write occurrence during data redistribution. In addition, FIG. 11 is an explanatory diagram illustrating an operation example at the time of write occurrence during the data redistribution. In FIGS. 10 and 11, it is assumed that the writing of the user data of the meta address data B and E occurs during the data redistribution. The new assigned node of the meta address data B and E is node #1.

Accordingly, the node #1 writes the user data in the RU (Step S1001). Next, the node #1 newly creates the logical-physical metadata pointing to the written user data (Step S1002). The node #1 registers the address of the new logical-physical metadata in the meta address data (step S1003). After the processing of step S1003 is completed, the node #1 ends the processing at the time of write occurrence during the data redistribution. In this manner, since writing during the data redistribution is writing in an empty region, the new assigned node may perform normal write processing even during the data redistribution.

FIG. 12 is a flowchart illustrating an example of the processing procedure at a time of read occurrence during data redistribution. In addition, FIG. 13 is an explanatory diagram illustrating an operation example at the time of read occurrence during the data redistribution. In FIGS. 12 and 13, it is assumed that the read-out of the user data of the meta address data E occurs during the data redistribution. The new assigned node of the meta address data E is node #1.

Accordingly, the node #1 determines whether or not the status of the meta address data E is not moved (Step S1201). In a case where the status of the meta address data E is not moved (Step S1201: not yet moved), the node #1 transmits an acquisition request of the logical-physical metadata to the original node of the meta address data E, that is, the node #0 (Step S1202). The notified node #0 acquires the logical-physical metadata of the meta address data E from the saved RU (Step S1203). The node #0 transmits the logical-physical metadata of the acquired meta address data E to the node #1 (Step S1204).

The node #1 additionally writes the logical-physical metadata of the received meta address data E in the RU of the node #1 (Step S1205). Next, the node #1 creates the meta address data E of the logical-physical metadata written additionally in the node #1 (Step S1206). The node #1 notifies the movement completion of the meta address data D to the node #0 (Step S1207). The node #0 received the notification of the movement completion from the node #1 sets the meta address data D as movement completion (Step S1208). After the processing of Step S1208 is completed, the node #0 ends the processing at the time of read occurrence during the data redistribution.

On the other hand, in a case where the status of the meta address data E is movement completion (step S1201: movement completion), the node #1 acquires the logical-physical metadata of the meta address data E at the own node (Step S1209). After the processing of Step S1207 or Step S1209 are completed, the node #1 reads the user data of the meta address data E from the RU (Step S1210). After the processing of Step S1210 is completed, the node #1 ends the processing at the time of read occurrence during the data redistribution.

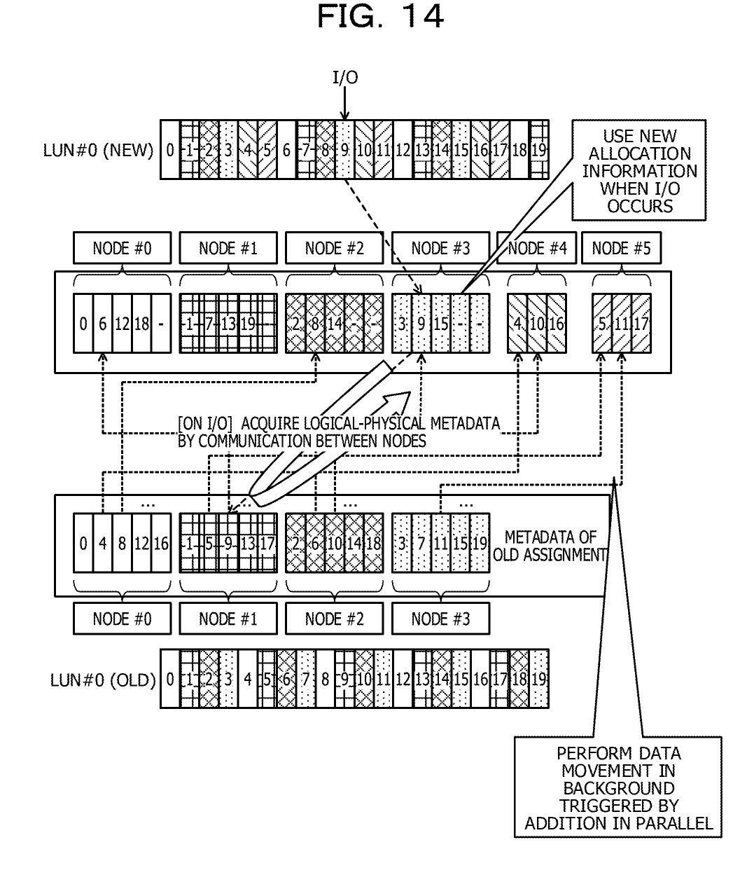

Next, with reference to a more specific example, a data movement procedure by the metadata management unit starting with expansion of pool capacity is illustrated. First, with reference to FIG. 14, a specific example of the data movement procedure by the metadata management unit is illustrated.

FIG. 14 is an explanatory diagram illustrating an operation example of a data movement procedure by the metadata management unit. In the example of FIG. 14, the distributed data is formed by the nodes #0 to #3 as original distribution, and the distributed data is formed by the nodes #0 to #5 as a new distribution. In addition, in FIG. 14, there are 0th to 19th data blocks in LUN #0. One data block is in units of 8 MB.

In FIG. 14, shading applied to the metadata distinguishes the allocation destination nodes. Specifically, the metadata allocated to the node #0 is illustrated as a rectangle with hollow. In addition, the metadata allocated to the node #1 is illustrated as a rectangle shaded with lattice. In addition, the metadata allocated to the node #2 is illustrated as a rectangle shaded with oblique lattice. In addition, the metadata allocated to the node #3 is illustrated as a rectangle shaded with dot polka dots. In addition, the metadata allocated to the node #4 is illustrated as a rectangle shaded with oblique lines from the upper left to the lower right. In addition, the metadata allocated to the node #5 is illustrated as a rectangle shaded with oblique lines from the upper right to the lower left. For example, 0th, 4th, 8th, 12th, and 16th metadata of LUN #0 are allocated to the node #0 as the original distribution. The 0th, 6th, 12th, and 18th metadata of LUN #0 are allocated as new distribution.

During the capacity expansion processing of the pool, the metadata management unit of each of the nodes writes all 16 GB meta address cache in the storage apparatus 202, clears once with the logical-physical metacache, and sets two sides of a logical volume region and a meta address region. Here, the two-sided setting means securing a logical volume region used as the original distribution and a new empty region in which the meta address region is saved as it is and used as the movement source information. In addition, the metadata management unit of the added node creates the volume and secures the RU storing the meta address region. In addition, the metadata management unit of each of the nodes initializes the status of the meta address data for the new allocation in the “not moved” state.

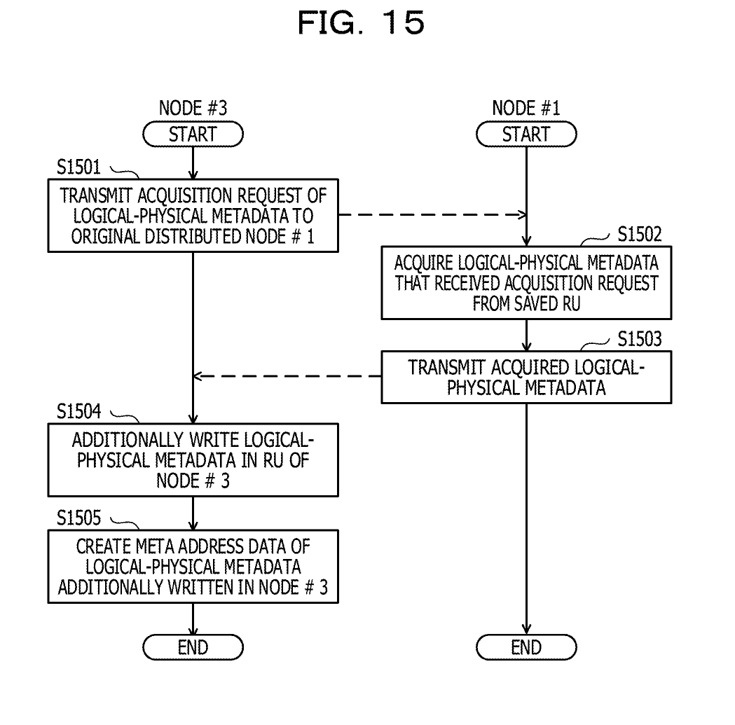

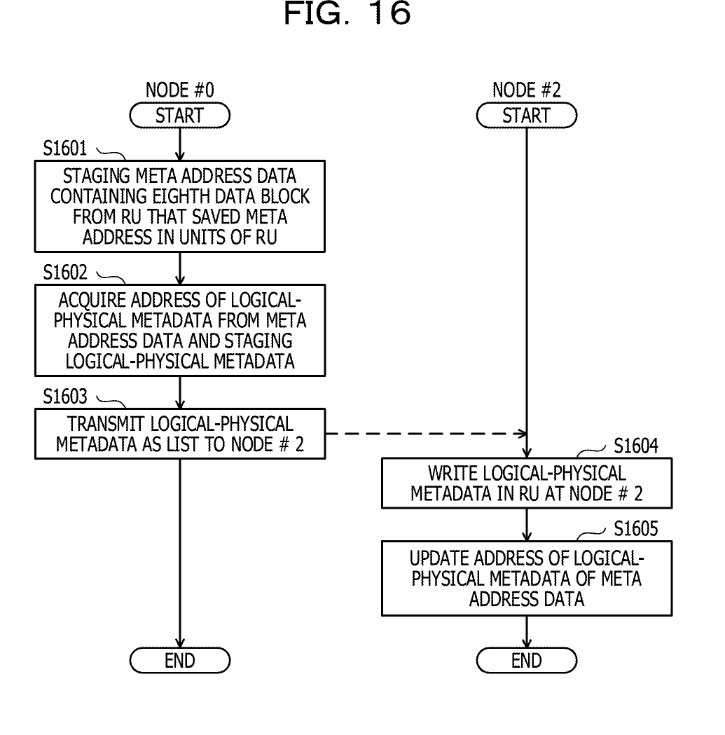

In FIG. 14, processing at the time of I/O is illustrated with a large arrow, and the data movement processing in the background triggered by addition is illustrated with dotted line arrows. Although the dotted arrows illustrated in FIG. 14 are added to a part of the meta data to move data for convenience of display, and not illustrated with the dotted arrows, the 16th, 17th, 18th, 7th, 11th, and 19th metadata of LUN #0 are subject to background movement. Next, with reference to FIG. 15, a flowchart of the metadata movement processing of the read I/O processing trigger will be described, and with reference to FIG. 16, a flowchart of the background movement processing other than the added node will be described.

FIG. 15 is a flowchart illustrating an example of a metadata movement processing procedure of a read I/O processing trigger. The flowchart illustrated in FIG. 15 corresponds to the flowchart illustrated in FIG. 12.

In the flowchart illustrated in FIG. 15, it is assumed that there is a read I/O to the address between 64 MB to 72 MB of LUN #0. Since one block size is 8 MB, it is for the ninth data block of LUN #0, and in the new distribution, the node to which the ninth data block is allocated is the node #3. In addition, in the original distribution, the node to which the ninth data block is allocated is the node #1.

Accordingly, the node #3 transmits the acquisition request of the logical-physical metadata to the original distributed node #1 (Step S1501). The node #1 that received the acquisition request acquires the logical-physical metadata that received the acquisition request from the saved RU (Step S1502). The node #1 transmits the acquired logical-physical metadata to the node #3 (Step S1503). After the processing of Step S1503 is completed, the node #1 terminates the metadata movement processing of the read I/O processing trigger.

The node #3 received the logical-physical metadata additionally writes the logical-physical metadata in the RU of the node #3 (Step S1504). The node #3 creates the meta address data of the logical-physical metadata additionally written in the node #3 (Step S1505). After the processing in step S1505 is completed, the node #3 ends the metadata movement processing of the read I/O processing trigger.

FIG. 16 is a flowchart illustrating an example of a background movement processing procedure other than an added node. The flowchart illustrated in FIG. 16 corresponds to the flowchart illustrated in FIG. 8. In addition, although there are a plurality of metadata to be moved in the background as illustrated in FIG. 14, the background of the eighth metadata of LUN #0 is illustrated in the flowchart illustrated in FIG. 16. In the new distribution, the node to which the eighth metadata is allocated is the node #2. In addition, in the original distribution, the node to which the eighth metadata is allocated is the node #0.

The node #0 performs staging of the meta address data containing the eighth data block from the RU that saved the meta address in units of RU (Step S1601). Next, the node #0 acquires the address of the logical-physical metadata from the meta address data and performs staging of the logical-physical metadata (Step S1602). The node #0 transmits the logical-physical metadata as a list to the node #2 (Step S1603). Here, the above-described list is a list of the logical-physical metadata to be transmitted to the destination node. In the example of FIG. 14, since the logical-physical metadata to be transmitted to the node #2 is only the eighth logical-physical metadata of LUN #0, the list includes only the eighth logical-physical metadata of LUN #0.

The node #2 writes the received logical-physical metadata in the RU at the node #2 (Step S1604). Next, the node #2 updates the address of the logical-physical metadata of the meta address data with the received logical-physical metadata (Step S1605).

The node other than the added node performs the processing illustrated in FIG. 16 for other metadata.

As described above, the storage system 200 stores the updated meta address data in a position corresponding to the logical address of the logical-physical metadata corresponding to the updated meta address data in the continuous storage region, and additionally writes the logical-physical metadata and the user data unit. As a result, since it is not desirable to overwrite and update the logical-physical metadata and the user data unit, it is possible to prolong the life of the storage apparatus 202 serving as the SSD.

In addition, as the movement processing, the storage system 200 transmits the logical-physical metadata allocated to each of the nodes to the node specified based on the method of specifying the movement destination node described in FIG. 1 among each of the nodes and the new node. As a result, in the storage system 200, even in the management method of the meta address data, the logical-physical metadata, and the user data unit, each of the nodes may perform multiple movement processing, and it is possible to shorten the time taken for redistribution. Furthermore, the logical-physical metadata corresponding to the user data unit is moved without moving the user data unit, so that each of the nodes may shorten the time taken for the movement processing for not moving the user data unit.

In addition, in a case where a write request is received after a new node has been added, the node received the write request may write the data to be written in the first empty storage region allocated by the own node. When the logical address of the received logical-physical metadata and the logical address of the logical-physical metadata written in the first empty storage region are different from each other, each of the nodes and the new node write the received logical-physical metadata in the first empty storage region. As a result, even in the management method of the meta address data, the logical-physical metadata, and the user data unit, the storage system 200 may not use monitoring on the movement map.

In addition, after a new node has been added, when there is no data with respect to the logical address to be read-out in the first empty storage region, the node received the read-out request transmits the acquisition request of the logical-physical metadata to the node specified based on the method of specifying the movement source node. As a result, even in the management method of the meta address data, the logical-physical metadata, and the user data unit, the storage system 200 may move the read-out partial data as it is.

The storage control method described in the embodiment may be realized by executing a prepared program on a computer such as a personal computer or a workstation. The storage control program is executed by being recorded in a computer readable recording medium such as a hard disk, a flexible disk, a compact disc-read only memory (CD-ROM), a digital versatile disk (DVD), and being read out from the recording medium by the computer. In addition, the storage control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage apparatus comprising:
a plurality of nodes, each of the plurality of nodes including:
a memory configured to store distributed data distributed and allocated to each of the plurality of nodes, and
a processor coupled to the memory and configured to:
secure an empty storage region different from a storage region storing the distributed data on the memory when a new node is added to the plurality of nodes, and
move the distributed data to the empty storage region secured in the plurality of nodes and the new node.

2. The storage apparatus according to claim 1,
wherein the processor transmits partial data serving as a portion of the distributed data to a node specified based on information on the new node, an address of the partial data, and a predetermined allocation rule, and
the specified node writes the received partial data in the empty storage region secured by the specified node.

3. The storage apparatus according to claim 2,
wherein when receiving a write request of the data to be written with respect to an address to be written after the new node has been added, the plurality of nodes and the new node write data to be written in the empty storage region secured by an own node, and
when the partial data is received, if data is not written in an address of the partial data in the empty storage region, the partial data is written in the empty storage region secured by the own node.

4. The storage apparatus according to claim 2,
wherein the plurality of nodes and the new node receive a read-out request with respect to an address to be read-in after the new node has been added, and
transmit an acquisition request with respect to the partial data including the address to be read-out to a node specified based on information on a node before node addition, the address to be read-out, and the predetermined allocation rule when there is no partial data with respect to the address to be read-out in the empty storage region secured by the own node,
the specified node transmits partial data corresponding to the address to be read-out from the held distributed data to a transmission source node of the acquisition request when the acquisition request is received, and
the transmission source node of the acquisition request transmits the received partial data to the transmission source of the read-out request and writes the received partial data in the empty storage region secured by the own node.

5. The storage apparatus according to claim 1,
wherein partial data of distributed data distributed and allocated to each of the plurality of nodes is first address information having a logical address and a physical address indicating a storage position storing data corresponding to the logical address, and
the processor records second address information having a physical address indicating a storage position of the first address information on the memory corresponding to the first address information,
stores an updated second address information at a position corresponding to the logical address of the first address information corresponding to the updated second address information in consecutive storage regions, and
stores the updated data corresponding to the logical address or the updated first address information in an empty storage region different from a storage region storing data corresponding to the logical address, the first address information, and the second address information,

6. The storage apparatus according to claim 5,
wherein the plurality of nodes and the new node hold the first address information allocated to the plurality of nodes, data corresponding to a logical address of the first address information, and second address information corresponding to the first address information, respectively, and
secure a first empty storage region and a second empty storage region serving as a continuous empty storage region, which are different from the storage region storing the first address information and data corresponding to the first address information and the logical address of the first address information among the storage region of the storage, and
the plurality of nodes transmits the first address information allocated to each of the plurality of nodes to a node specified based on information on the node after node addition, the logical address of the first address information, and the predetermined allocation rule, and
the specified node writes the received first address information in the first empty storage region secured by the specified node, and
writes second address information having a physical address indicating a storage position in which the received first address information is written in the second empty storage region secured by the specified node.

7. The storage apparatus according to claim 5,
wherein the plurality of nodes and the new node write the data to be written in the first empty storage region secured by the own node, when a write request of data to be written with respect to a logical address to be written is received after the new node has been added,
write first address information having a physical address indicating the storage position of the data to be written and the logical address to be written in the first empty storage region secured by the own node,
write second address information having a physical address indicating the storage position of the first address information written in the first empty storage region in the second empty storage region secured by the own node,
receive the first address information, and
write the received first address information in the first empty storage region secured by the own node when the logical address of the first address information written in the first empty storage region secured by the own node differs from the logical address of the received first address information.

8. The storage apparatus according to claim 5,
wherein the plurality of nodes and the new node receive a read-out request with respect to a logical address to be read-in after the new node is added,
transmit an acquisition request of first address information including the logical address to be read-out to a specified node based on the information on the node before the node addition, the logical address to be read-out, and the predetermined allocation rule when there is no data with respect to the logical address to be read-out in the first empty storage region secured by the own node,
transmit first address information including the logical address to be read-out from the held first address information to the transmission source node of the acquisition request when the acquisition request is received, and
read the data stored in the received physical address of the first address information when the first address information is received.

9. A storage control method executed by a storage apparatus including a plurality of nodes, each of the plurality of nodes having a memory and a processor coupled to the memory, comprising:
store distributed data distributed and allocated to each of the plurality of nodes;
securing an empty storage region different from a storage region storing the distributed data on the memory when a new node is added to the plurality of nodes; and
moving the distributed data to the empty storage region secured in the plurality of nodes and the new node.
